(19) United States
(12) Patent Application Publication
(10) Pub. No.: US 2025/0091265 A1
(43) Pub. Date: Mar. 20, 2025

(54) METHOD FOR MANUFACTURING KEYCAP

(71) Applicant: SUNREX TECHNOLOGY CORP., Taichung City (TW)

(72) Inventors: Chia-Chang HSU, Taichung City (TW); Chia-Hung TSAI, Taichung City (TW)

(73) Assignee: SUNREX TECHNOLOGY CORP., Taichung City (TW)

(21) Appl. No.: 18/392,347

(22) Filed: Dec. 21, 2023

(30) Foreign Application Priority Data
Sep. 18, 2023 (TW) 112135568

(51) Int. Cl. B29C 45/00; B29C 35/02; B29C 45/03; B29C 45/14; B29C 45/17

(52) U.S. Cl. CPC B29C 45/0053; B29C 35/02; B29C 45/03; B29C 45/17; B29C 2045/0079; B29C 2045/1486

(57) ABSTRACT

A method for manufacturing a keycap includes a plastic injection step that involves forming a keycap preform; a coating layer forming step that involves spraying a surface paint material onto a processing surface of the keycap preform to form a surface paint coating layer, which has an engraved marking portion; a protection layer forming step that involves spraying a protection material onto the surface paint coating layer to form a first protection layer; a laser engraving step that involves removing the engraved marking portion; and a screen printing step that involves forming a second protection layer on the processing surface.

### CROSS-REFERENCE TO RELATED APPLICATION

This application claims priority to Taiwanese Invention Patent Application No. 112135568, filed on Sep. 18, 2023, the entire disclosure of which is incorporated by reference herein.

### FIELD

The disclosure relates to a manufacturing method, and more particularly to a method for manufacturing a keycap.

### BACKGROUND

A conventional method for manufacturing a keycap according to Taiwanese Patent Publication No. TW 201131602A includes steps of: 1) a colored plastic injection molding step that involves pre-forming a colored plastic unit having a processed surface; 2) a spraying step that involves spraying a surface paint material onto the processed surface; 3) a baking step that involves curing the surface paint material on the processed surface so that the surface paint material becomes a surface paint layer; 4) a laser engraving step that involves processing the surface paint layer by a laser beam so that an engraved marking portion is formed on the surface paint layer; and 5) a transparent layer covering step that involves covering the engraved marking portion and the surface paint layer with a transparent protection layer for protection purposes.

However, in response to the current collaborative production model of the manufacturing industry, the plastic injection molding step usually takes place at a first production site where a large quantity of colored plastic units are produced. Then, the laser engraving step takes place at a second production site where the engraved marking portion is processed according to different languages. Various series of keycaps are thus formed. If adopting the conventional method for manufacturing a keycap, both of the first production site and the second production site need to purchase a spraying device for applying the surface paint material or the transparent protection layer, thereby increasing equipment cost. Thus, there is room for improvement in the conventional method for manufacturing a keycap.

### SUMMARY

Therefore, an object of the disclosure is to provide a method for manufacturing a keycap that can alleviate at least one of the drawbacks of the prior art.

According to the disclosure, the method for manufacturing a keycap, which is cooperatively implemented by a plastic injection device, a spraying device, a laser device, and a screen printing device, includes steps of:
(A) a plastic injection step that involves forming a keycap preform using a plastic injection device, the keycap preform including a processing surface and a surrounding surface that surrounds the processing surface;
(B) a coating layer forming step that involves spraying a surface paint material, which has a color different from a color of the keycap preform, onto the processing surface using the spraying device, so as to form a surface paint coating layer on the processing surface, the surface paint coating layer having an engraved marking portion and a coating layer body;
(C) a protection layer forming step that involves spraying a protection material, which is transparent, onto the surface paint coating layer using the spraying device, so as to form a first protection layer covering the surface paint coating layer, the first protection layer having a marking protection portion that corresponds to the engraved marking portion in position and a protection layer body that corresponds to the coating layer body in position;
(D) a laser engraving step that involves removing the engraved marking portion and the marking protection portion using the laser device, so as to reveal an exposed portion of the processing surface corresponding to the engraved marking portion and the marking protection portion in position; and
(E) a screen printing step that involves forming a second protection layer, which is transparent, on the processing surface using the screen printing device, the second protection layer covering the exposed portion of the processing surface that corresponds to the engraved marking portion and the marking protection portion in position.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating an embodiment of a method for manufacturing a keycap according to the disclosure.

FIG. 2 is a perspective view illustrating a keycap body formed in a step of the embodiment according to the disclosure.

FIG. 3 is a perspective view illustrating a keycap preform formed in another step of the embodiment according to the disclosure.

FIG. 4 is a perspective view illustrating a surface paint layer formed on the keycap preform.

FIG. 5 is a perspective view illustrating a first protection layer covering and formed on the surface paint layer and the keycap preform.

FIG. 6 is a perspective view illustrating a second protection layer covering and formed on a portion of the keycap preform corresponding to portions of the first protection layer and the surface paint layer that are removed.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

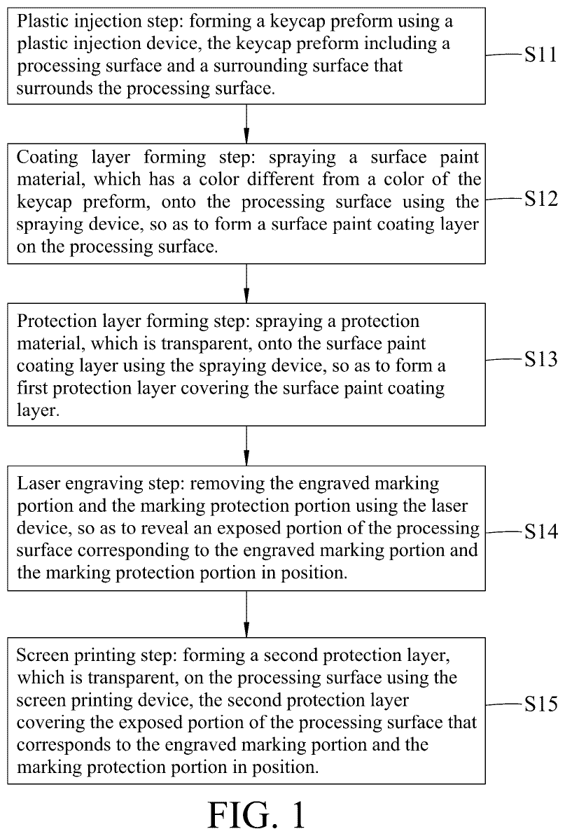

Referring to FIG. 1, according to an embodiment of the disclosure, a method for manufacturing a keycap is cooperatively implemented by a plastic injection device (not shown), a spraying device (not shown), a laser device (not shown), and a screen printing device (not shown).

In this embodiment, the plastic injection device is a hydraulic injection molding machine, an all-electric injection molding machine, or an oil-electric composite injection molding machine. The spraying device includes a spray gun and an oven. The laser device is a red light laser engraver or an optical fiber laser engraver. The screen printing device includes a screen mesh, a printer bed, a screen frame for applying materials, a squeegee for scraping off excess materials, and an ultraviolet lamp for drying.

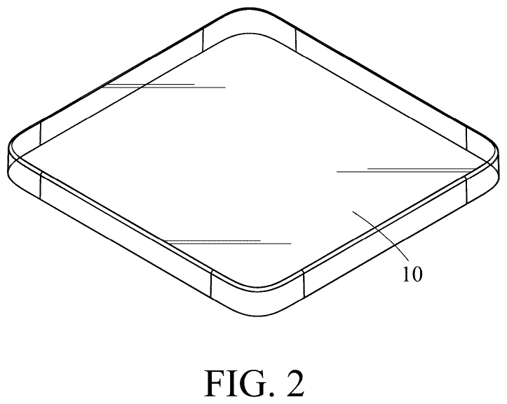

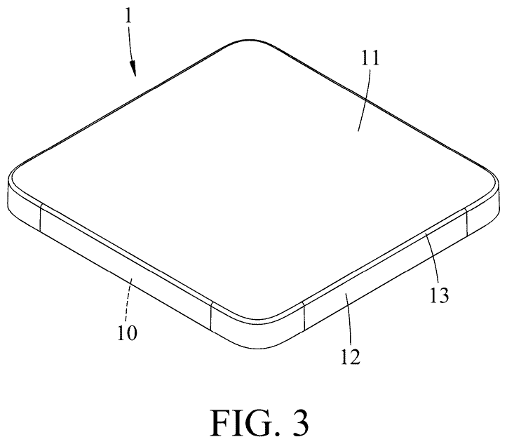

When being implemented, the method includes the following steps.
Step S11 (a plastic injection step): referring to FIGS. 1, 2, and 3, a keycap preform 1 is formed using the plastic injection device. The keycap preform 1 includes a processing surface 11 and a surrounding surface 12 that surrounds the processing surface 11.

In this embodiment, a keycap body 10, which is transparent, is formed by injection molding using the plastic injection device. Then, using the spray gun of the spraying device, the keycap body 10 is sprayed with a base paint material having a color different from a color of the keycap body 10 so that a base paint coating layer 13 is formed on the keycap body 10. The keycap body 10 and the base paint coating layer 13 cooperatively form the keycap preform 1, and the base paint layer 13 forms the processing surface 11 and the surrounding surface 12. The base paint material may be acrylic paint or polyurethane paint. The color of the base paint layer 13 may be white but is not limited to.

In a variant embodiment, after the keycap body 10 is formed by injection molding using the plastic injection device, the spray gun of the spraying device may be used to spray the base paint material onto a top surface of the keycap body 10, to ensure the processing surface 11 of the keycap preform 1 to have the color of the base paint material. In this case, the base paint layer 13 forms the processing surface 11, and the keycap body 10 forms the surrounding surface 12.

In yet another variant embodiment, using the plastic injection device, the keycap preform 1 may be directly formed by injection molding a colored plastic material, but is not limited to.

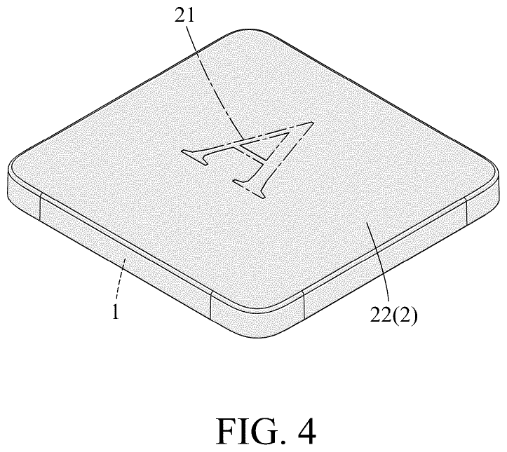

Referring to FIGS. 1, 3 and 4, Step S12 (a coating layer forming step): a surface paint material, which has a color different from a color of the keycap preform 1 is sprayed onto the processing surface 11 using the spray gun of the spraying device, so as to form a surface paint coating layer 2 on the processing surface 11. The surface paint coating layer 2 has an engraved marking portion 21 and a coating layer body 22, and exhibits the color of the surface paint material.

In this embodiment, after the processing surface 11 is sprayed with the surface paint material by the spray gun of the spraying device, the surface paint material is baked by the oven of the spraying device so that the surface paint material is cured and forms the surface paint coating layer 2. The surface paint material may be acrylic paint or polyurethane paint. The color of the surface paint coating layer 2 may be black but is not limited to.

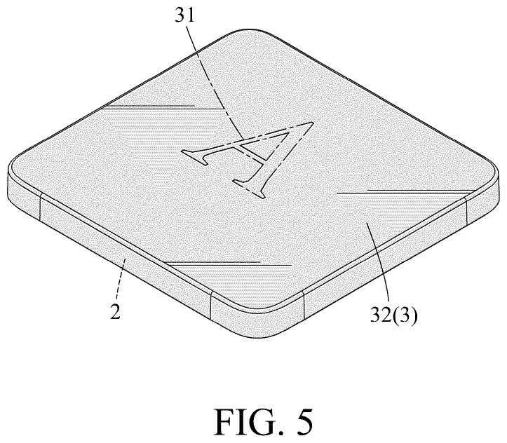

Referring to FIGS. 1, 4, and 5, Step S13 (a protection layer forming step): a protection material, which is transparent, is sprayed onto the surface paint coating layer 2 using the spray gun of the spraying device, so as to form a first protection layer 3 covering the surface paint coating layer 2. The first protection layer 3 has a marking protection portion 31 that corresponds to the engraved marking portion 21 in position, and a protection layer body 32 that corresponds to the coating layer body 22 in position.

In this embodiment, the surface paint coating layer 2 is sprayed with the protection material by the spray gun of the spraying device, and then the protection material is baked by the oven of the spraying device so that the protection material is cured and forms the first protection layer 3.

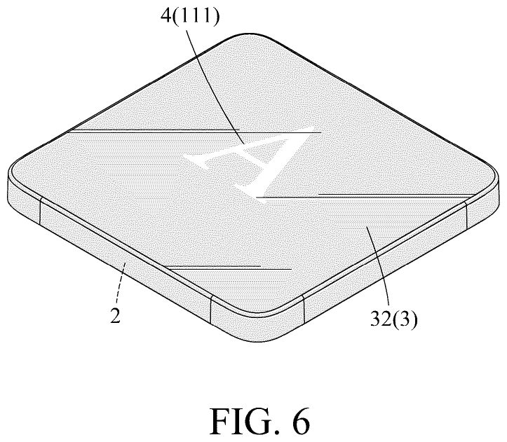

Referring to FIGS. 1, 4, 5, and 6, Step S14 (a laser engraving step): the engraved marking portion 21 and the marking protection portion 31 are removed using the laser device, so as to reveal an exposed portion 111 of the processing surface 11 corresponding to the engraved marking portion 21 and the marking protection portion 31 in position.
Step S15 (a screen printing step): a second protection layer 4, which is transparent, is formed on the processing surface 11 using the screen printing device. The second protection layer 4 covers the exposed portion 111 of the processing surface 11 that corresponds to the engraved marking portion 21 and the marking protection portion 31 in position.

In this embodiment, the screen printing device is utilized to fill an ultraviolet curing material, which is transparent, in a groove that is cooperatively defined by the exposed portion 111 of the processing surface 11, the coating layer body 22, and the protection layer body 32 (to be specific, after step S14, the ultraviolet curing material is applied onto the first protection layer 3 using the screen printing device, and an excess of the ultraviolet curing material is removed using the squeegee of the screen printing device so as to permit the groove to be filled with the ultraviolet curing material). Then, using the ultraviolet lamp of the screen printing device, an ultraviolet light beam is emitted toward the ultraviolet curing material, so that the ultraviolet curing material is cured and forms the second protection layer 4, thereby allowing the second protection layer 4 to cover the exposed portion 111 of the processing surface 11. The second protection layer 4 is an ultraviolet (UV) light curing layer, such as a UV ink layer.

In summary, in response to the current collaborative production model, where the plastic injection molding step takes place at a first production site to produce a large quantity of keycap preforms 1, and where the laser engraving step takes place at a second production site, corresponding effects produced by the method for manufacturing a keycap according to the disclosure are as follows:
1) By using the spraying device to pre-conduct step S11 to step S13 at the first production site, the keycap preform 1 sprayed with the surface paint coating layer 2 and the first protection layer 3 is formed, and the surface paint coating layer 2 is covered by the first protection layer 3, thereby preventing the surface paint coating layer 2 from peeling off during transit from the first production site to the second production site.
2) By using the laser device to conduct subsequent step S14 to step S15 at the second production site, after the exposed portion 111 of the processing surface 11 corresponding to the engraved marking portion 21 and the marking protection portion 31 in position is revealed, the second protection later 4 fills and covers the groove, thereby preventing the surface paint coating layer 2 and the first protection layer 3 from rubbing sideways (e.g., by a finger) during use due to height difference of the groove itself.
3) In response to the collaborative production model, there is no need to purchase the spraying device at both of the first production site and the second production side, thereby reducing equipment cost.

Therefore, the method for manufacturing a keycap according to the disclosure may achieve the object of the disclosure through the abovementioned simple steps.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing a keycap, which is cooperatively implemented by a plastic injection device, a spraying device, a laser device, and a screen printing device, comprising steps of:
(A) a plastic injection step that involves forming a keycap preform using a plastic injection device, the keycap preform including a processing surface and a surrounding surface that surrounds the processing surface;
(B) a coating layer forming step that involves spraying a surface paint material, which has a color different from a color of the keycap preform, onto the processing surface using the spraying device, so as to form a surface paint coating layer on the processing surface, the surface paint coating layer having an engraved marking portion and a coating layer body;
(C) a protection layer forming step that involves spraying a protection material, which is transparent, onto the surface paint coating layer using the spraying device, so as to form a first protection layer covering the surface paint coating layer, the first protection layer having a marking protection portion that corresponds to the engraved marking portion in position and a protection layer body that corresponds to the coating layer body in position;
(D) a laser engraving step that involves removing the engraved marking portion and the marking protection portion using the laser device, so as to reveal an exposed portion of the processing surface corresponding to the engraved marking portion and the marking protection portion in position; and
(E) a screen printing step that involves forming a second protection layer, which is transparent, on the processing surface using the screen printing device, the second protection layer covering the exposed portion of the processing surface that corresponds to the engraved marking portion and the marking protection portion in position.

2. The method for manufacturing the keycap as claimed in claim 1, wherein
step (A) includes a substep (A-1) and a substep (A-2) that follows the substep (A-1),
in substep (A-1), a keycap body, which is transparent, is formed by injection molding using the plastic injection device;
in substep (A-2), the keycap body is sprayed with a base paint material having a color different from a color of the keycap body by the spraying device so that a base paint coating layer is formed on the keycap body, the keycap body and the base paint coating layer cooperatively forming the keycap preform.

3. The method for manufacturing the keycap as claimed in claim 1, wherein step (B) includes a substep (B-1) and a substep (B-2) that follows the substep (B-1),
in substep (B-1), the processing surface is sprayed with the surface paint material by the spraying device;
in substep (B-2), the surface paint material is baked by the spraying device so that the surface paint material is cured and forms the surface paint coating layer.

4. The method for manufacturing the keycap as claimed in claim 1, wherein step (C) includes a substep (C-1) and a substep (C-2) that follows the substep (C-1),
in substep (C-1), the surface paint coating layer is sprayed with the protection material by the spraying device;
in substep (C-2), the protection material is baked by the spraying device so that the protection material is cured and forms the first protection layer.

5. The method for manufacturing the keycap as claimed in claim 1, wherein
step (E) includes a substep (E-1) and a substep (E-2) that follows the substep (E-1),
in substep (E-1), the screen printing device is utilized to fill an ultraviolet curing material that is transparent in a groove that is cooperatively defined by the exposed portion of the processing surface, the coating layer body, and the protection layer body;
in substep (E-2), an ultraviolet light beam is emitted toward the ultraviolet curing material by the screen printing device, so that the ultraviolet curing material is cured and forms the second protection layer, thereby allowing the second protection layer to cover the exposed portion of the processing surface.
